(19) United States
(12) Patent Application Publication
(10) Pub. No.: US 2017/0004903 A1
(43) Pub. Date: Jan. 5, 2017

(54) WIRE HARNESS HAVING FIXING MEMBER

(71) Applicant: SUMITOMO WIRING SYSTEMS, LTD., Mie (JP)

(72) Inventor: Ryo SUENAGA, Mie (JP)

(73) Assignee: SUMITOMO WIRING SYSTEMS, LTD., Mie (JP)

(21) Appl. No.: 15/038,867

(22) PCT Filed: Dec. 5, 2014
(86) PCT No.: PCT/JP2014/082199

§ 371 Date: May 24, 2016

(30) Foreign Application Priority Data
Dec. 12, 2013 (JP) 2013-256817

(51) Int. Cl. H01B 7/00; F16B 2/08; B60R 16/02

(52) U.S. Cl. CPC H01B 7/0045; B60R 16/0215; F16B 2/08

(57) ABSTRACT

To achieve, with a simple configuration and simple work, a configuration in which a wire fixating member with band is mounted to a wire harness in a state capable of movement relative to the wire harness. A wire fixating member with band is wound around a wire harness and includes: a vehicle fixation portion capable of fixating to a vehicle; a band fixation portion provided to the vehicle fixation portion and having an engagement claw inside a band insertion hole; and a band formed in a strip shape extending from the band fixation portion. The band includes, at a location separated from a base end of the band, an engagement groove with which the engagement claw can engage.

### FIELD OF THE INVENTION

The present invention relates to a technology fixating wires or the like to a vehicle.

### BACKGROUND OF THE INVENTION

Patent Literature 1 discloses a wire harness that includes a cable, a plate member arranged along the cable, and a pair of clip bands bundling the cable and plate member. The plate member has an irregular shape, and the pair of clip bands are each fitted into respective portions of the irregular shape. Accordingly, an interval between the pair of clip bands is regulated. In the technology disclosed in Patent Literature 1, the clip bands are tightened around the cable and plate member. Therefore, the clip bands are expected to be unlikely to displace in a length direction or a circumference direction of the cable.

### RELATED ART

### Patent Literature

Patent Literature 1: Japanese Patent Laid-open Publication No. 2012-110100

### SUMMARY OF THE INVENTION

### Problems to be Solved by the Invention

When assembling the wire harness into the vehicle, due to the wire harness twisting or the like, in some cases it may be difficult to install a vehicle fixation portion in an appropriate position to insert the vehicle fixation portion toward a fixation hole formed in the vehicle and attach the vehicle fixation portion, and inserting the vehicle fixation portion into the fixation hole and attaching the vehicle fixation portion to the vehicle may be difficult.

A wire fixating member with band may be attached to a wire harness so as to be capable of displacement relative to the wire harness.

A configuration accomplishing this may be a configuration in which a corrugated tube having an interior diameter greater than an exterior diameter of a wire harness sheathes the wire harness, and a member fixating the corrugated tube to a vehicle is fixated to the corrugated tube with adhesive tape or the like (first example). According to this first exemplary configuration, the fixation member can be rotated around the wire harness together with the corrugated tube.

Also, a configuration may be used in which, in a state where a separate iron core lies alongside a wire harness, a wire fixating member with band is wrapped around the wire harness and iron core, after which the iron core is removed, enabling the band to rotate around the wire harness (second example).

However, according to the first example, after the corrugated tube sheathes the exterior of the wire harness, the fixation member must be fixated to the corrugated tube. Therefore, there are a large number of components attached to the wire harness, complicating attachment work.

The second example requires work to wind the band in a state where the iron core lies alongside the wire harness, and work to then remove the iron core.

Given this, the present invention enables, with a simple configuration and simple work, a configuration to be achieved in which a wire fixating member with band is attached to a wire harness in a state capable of displacement relative to the wire harness. Means for Solving the Problems

In order to resolve the above-noted circumstances, a first aspect is a wire fixating member with band wound around a wire harness and including: a vehicle fixation portion capable of fixating to a vehicle; a band fixation portion provided to the vehicle fixation portion and including an engagement claw inside a band insertion hole; and a band. The band is formed in a strip shape extending from the band fixation portion, and includes, at a location separated from a base end of the band, an engagement groove with which the engagement claw can engage.

A second aspect is the wire fixating member with band according to the first aspect, in which the engagement groove is provided at the location separated from the base end of the band to a degree enabling the band to form a ring shape of a circumferential length greater than an outer circumferential length of the wire harness in a state where the engagement claw is engaged with the engagement groove.

A third aspect is the wire fixating member with band according to the first or second aspect, in which the engagement groove is provided at a location separated from a forefront end of the band.

A fourth aspect is the wire fixating member with band according to any one of the first to third aspects, in which between one and six engagement grooves are provided.

A fifth aspect is the wire fixating member with band according to any one of the first to fourth aspects, in which the engagement groove is provided at only one location on the band.

A sixth aspect is the wire fixating member with band according to the first aspect, in which the engagement groove is provided at a plurality of locations at intervals on the band.

A wire harness with fixating member according to a seventh aspect includes a wire harness; and the wire fixating member with band according to any one of the first to sixth aspects attached to the wire harness in a state where the band is wrapped around the wire harness.

### Effect of the Invention

According to the first through seventh aspects, the engagement groove is provided to the band at a location separated from the base end of the band. Therefore, in a state where the engagement claw is engaged with the engagement groove, the circumferential length of the ring shape formed by the band can be defined to be at least a constant length. Also, in a state where the engagement claw is engaged with the engagement groove, by configuring the circumferential length of the band to be larger than the outer circumferential length of the wire harness, the wire fixating member with band can be attached to the wire harness in a state capable of movement with a simple configuration and simple work.

According to the second aspect, in a state where the engagement claw is engaged with the engagement groove, the circumferential length of the ring shape formed by the band can be made larger than the outer circumferential length of the wire harness 12.

According to the third aspect, in a state where the engagement claw is engaged with the engagement groove, the circumferential length of the ring shape formed by the band can be further limited.

According to the fourth aspect, because between one and six engagement grooves are provided, the range over which the engagement claw engages with the engagement groove in the extension direction of the band can be further limited, and the range of the circumferential length of the ring shape formed by the band can be further limited.

According to the fifth aspect, the location where the engagement claw engages with the engagement groove can be limited to only one location in the extension direction of the band, and the circumferential length of the ring shape formed by the band can be limited to a single circumferential length.

According to the sixth aspect, a plurality of locations where the engagement claw engages with the engagement groove are provided in the extension direction of the band, and a plurality of circumferential lengths of the ring shape formed by the band can be achieved.

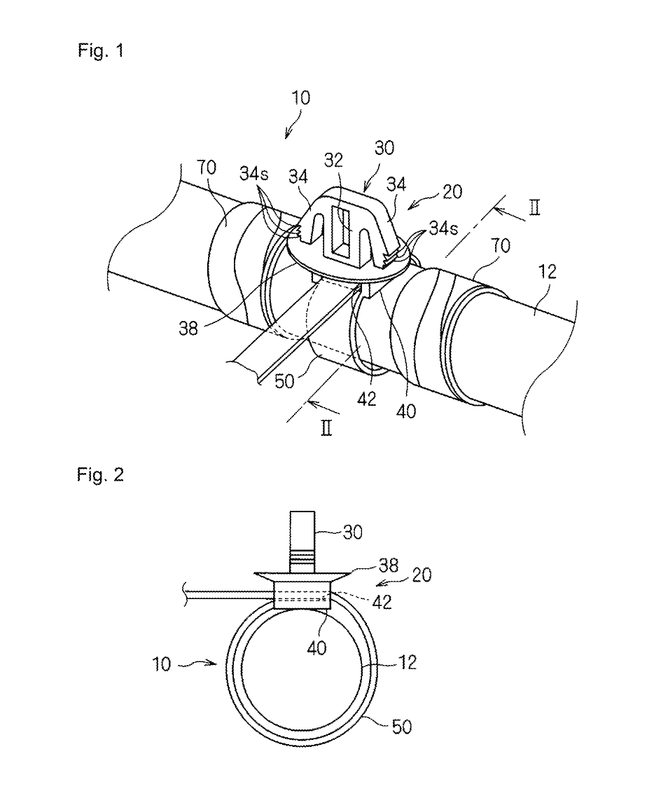

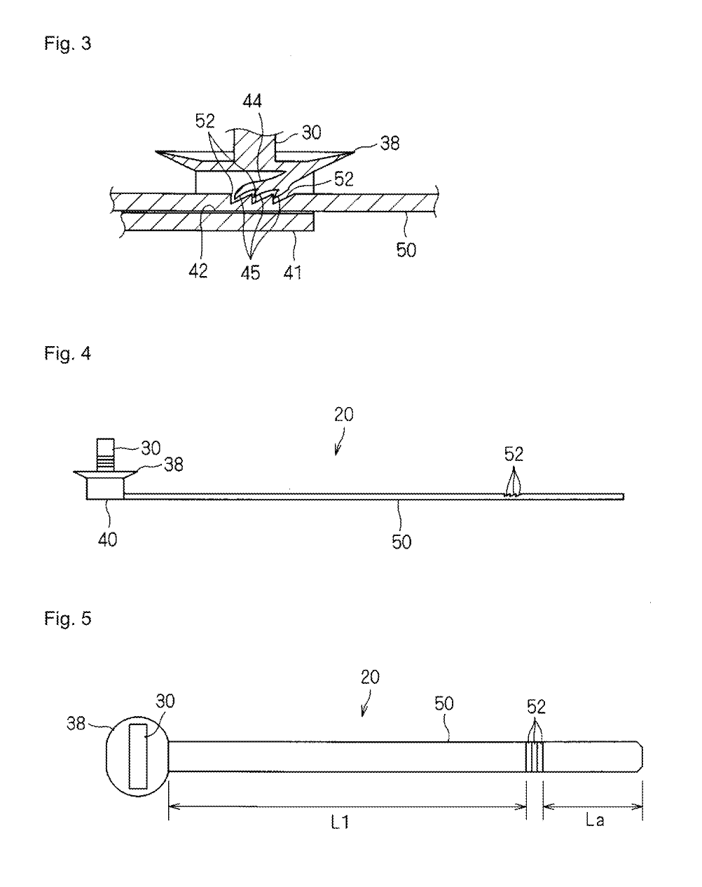

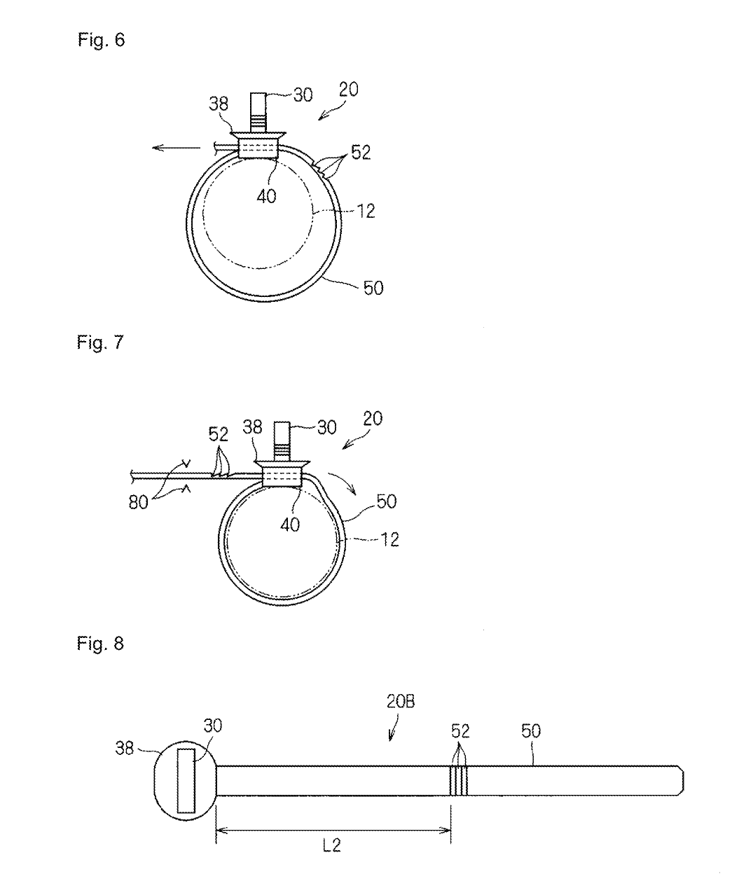

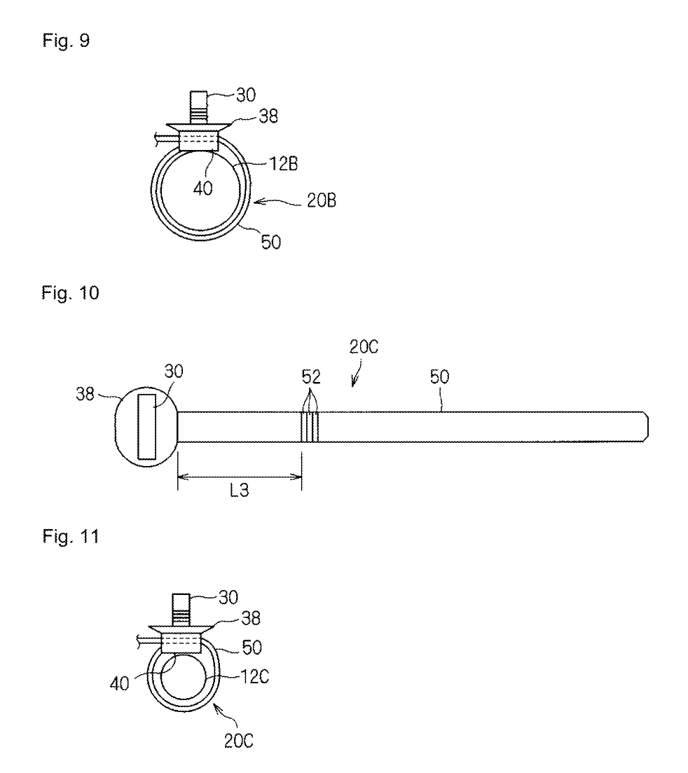

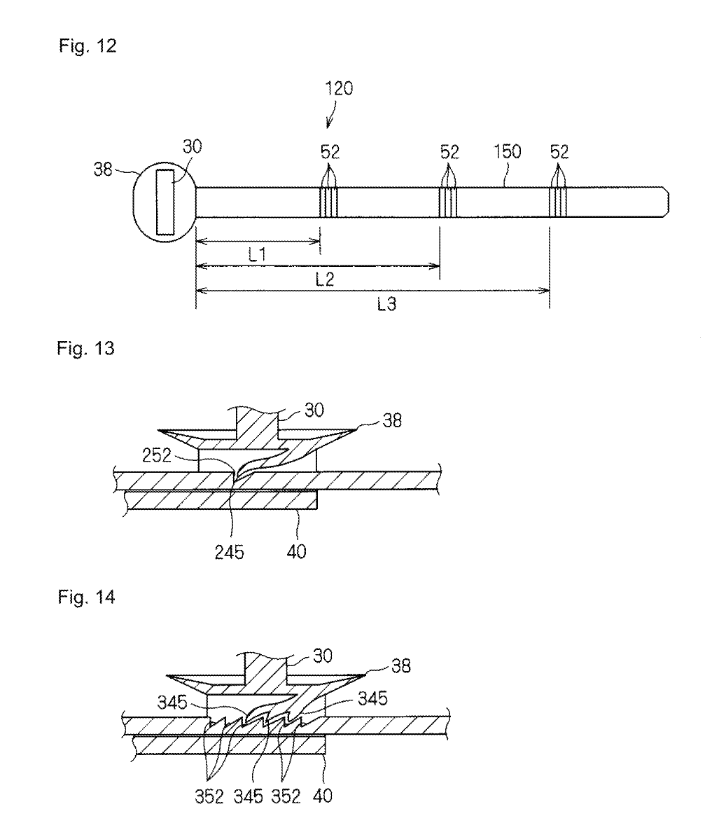

### BRIEF DESCRIPTION OF THE DRAWINGS

[FIG. 1] is a schematic perspective view of a wire harness with fixating member.

[FIG. 2] is a schematic cross-sectional view along a line II-II in FIG. 1.

[FIG. 3] is a partial schematic cross-sectional view of the wire harness with fixating member.

[FIG. 4] is a lateral view of a wire fixating member with band.

[FIG. 5] is a plan view of the wire fixating member with band.

[FIG. 6] is an explanatory view of a process of attaching the wire fixating member with band to a wire harness.

[FIG. 7] is an explanatory view of a process of attaching the wire fixating member with band to a wire harness.

[FIG. 8] is a plan view of the wire fixating member with band, where a position of engagement grooves is changed.

[FIG. 9] illustrates a state where the wire fixating member with band is attached to the wire harness.

[FIG. 10] is a plan view of the wire fixating member with band, where the position of the engagement grooves is changed.

[FIG. 11] illustrates a state where the wire fixating member with band is attached to the wire harness.

[FIG. 12] is a plan view of the wire fixating member with band having engagement grooves provided at a plurality of locations.

[FIG. 13] is a partial schematic cross-sectional view of a modification related to an engagement claw and engagement groove.

[FIG. 14] is a partial schematic cross-sectional view of another modification related to the engagement claw and engagement groove.

### MODE FOR CARRYING OUT THE INVENTION

In the following, a wire fixating member with band and a wire harness with fixating member according to an embodiment are described. FIG. 1 is a schematic perspective view of a wire harness with fixating member 10. FIG. 2 is a schematic cross-sectional view along a line II-II in FIG. 1. FIG. 3 is a partial schematic cross-sectional view of the wire harness with fixating member 10. FIG. 4 is a lateral view of a wire fixating member with band 20. FIG. 5 is a plan view of the wire fixating member with band 20. The various drawings provide simplified illustrations of a wire harness 12.

The wire harness with fixating member 10 includes the wire harness 12 and the wire fixating member with band 20.

The wire harness 12 is configured by bundling a plurality of electric wires. The wire harness 12 may be divided into branches as appropriate. In addition, the wire harness 12 may include fiber optic cables and the like.

At an end portion of the wire harness 12, end portions of the wires are connected to connectors or the like. In a state where the wire harness with fixating member 10 is fixated to a vehicle via the wire fixating member with band 20 or the like, by connecting each of the connectors or the like to various electronic components in the vehicle, the various electronic components are electrically connected via the wire harness 12.

The wire fixating member with band 20 includes a vehicle fixation portion 30, a band fixation portion 40, and a band 50. In this example, the wire fixating member with band 20 is a component that is integrally molded by injecting molten resin into a die. The wire fixating member with band 20 may be attached to the wire harness 12 in a state where the band 50 is wrapped around the wire harness 12. In addition, by fixating the vehicle fixation portion 30 to the vehicle, the wire harness 12 can be fixated at a constant position with respect to the vehicle.

The vehicle fixation portion 30 is a portion configured to be capable of fixating to the vehicle. In this example, the vehicle fixation portion 30 is configured to be capable of being inserted and fixated in a fixation hole formed in a panel at an attachment location of the vehicle.

More specifically, the vehicle fixation portion 30 is a portion called a clip or a clamp and includes a pillar 32 and a pair of engagement portions 34 provided to a forefront end of the pillar 32.

The pillar 32 is configured with an elongated portion projecting from the band fixation portion 40. The pair of engagement portions 34 are formed in a shape extending so as to incline outward from the forefront end of the pillar 32 toward a base end. A plurality of step portions 34s, oriented toward the forefront ends, are provided on an outward-facing portion of the forefront ends of the pair of engagement portions 34. In addition, a maximum width of the forefront ends of the pair of engagement portions 34 is configured to be larger than a diameter of the fixation hole (in a case where the fixation hole is oblong, the maximum width is configured to be larger than a major axis of the fixation hole). Also, when inserted into the fixation hole with the vehicle fixation portion 30, the pair of engagement portions 34 abut a circumferential edge of the fixation hole and elastically deform so as to be narrowed. When the pair of engagement portions 34 pass the circumferential edge of the fixation hole, the pair of engagement portions 34 elastically revert to their original shape and one of the steps 34s is retention engaged on the circumferential edge of the fixation hole. This fixates the vehicle fixation portion 30 at a location on the vehicle where the fixation hole is formed.

A plate spring 38 is formed oriented away from the base end portion and toward the forefront end of the pillar 32, and spreads around the circumference of the pillar 32. In a state where the step portions 34s of the pair of engagement portions 34 are engaged with the circumferential edge of the fixation hole, as described above, the plate spring 38 abuts the , circumferential edge of the fixation hole, which is the panel at the attachment location, from the opposite side. Accordingly, in a state where the circumferential edge of the fixation hole, which is the panel at the attachment location, is held between the pair of engagement portions 34 and the plate spring 38, the vehicle fixation portion 30 is fixated to the panel at the attachment location.

In addition to the above-described configuration, the vehicle fixation portion may have a configuration in which a bolt or long fixation member (such as a member sometimes referred to as a bracket) provided to a vehicle body is inserted into and fixated to the vehicle fixation portion.

The band fixation portion 40 is provided to the vehicle fixation portion 30 and is configured so as to be capable of fixating the band 50 at a constant position in an extension direction of the band 50.

Specifically, the band fixation portion 40 has a configuration in which a band insertion hole 42 is formed; more specifically, the band fixation portion 40 is formed in a quadrangular cylinder shape and has a configuration in which the band insertion hole 42, having a quadrangular hole shape, is formed in an interior thereof. The band fixation portion 40 is formed such that a band engagement portion 44 projects from one interior circumferential surface of the band insertion hole 42. In this example, the band engagement portion 44 is formed so as to project from an interior circumferential surface of the band insertion hole 42 that is on the vehicle fixation portion 30 side of the band insertion hole 42. The band engagement portion 44 extends from a position closer to an opening on a first end of the band insertion hole 42 while inclining toward an opening on a second end of the band insertion hole 42. In addition, an engagement claw 45 is formed at the forefront end of the band engagement portion 44. In this example, three engagement claws 45 are formed at the forefront end of the band engagement portion 44. Furthermore, each of the engagement claws 45 is formed in the shape of a triangular projection having a surface facing the opening on the first end side of the band insertion hole 42 and a surface facing the opening on the second end side of the band insertion hole 42 (see FIG. 3). The surface of the engagement claw 45 facing the opening on the first end side of the band insertion hole 42 (surface facing right in FIG. 3) and the surface of the engagement claw 45 facing the opening on the second end side of the band insertion hole 42 (surface scooping left in FIG. 3) incline toward the opening at the second end side of the band insertion hole 42 toward the forefront end of each surface, and even when the engagement claws 45 are viewed in totality, the engagement claws 45 are formed in the shape of a triangular projection inclined in a direction toward the opening at the second end side of the band insertion hole 42. When the band 50 is inserted through the opening at the first end side of the band insertion hole 42 toward the opening at the second end side, each of the engagement claws 45 can readily pass over engagement grooves 52 formed in the band 50. In contrast, when the band 50 is pulled back from the opening at the second end side toward the opening at the first end side of the band insertion hole 42, each of the engagement claws 45 catches on the engagement grooves 52 formed in the band 50 and is unlikely to pass over the engagement grooves 52.

The band engagement portion may instead project from an interior circumferential surface of the band insertion hole that is on the opposite side of the band insertion hole from the vehicle fixation portion. Also, the engagement claws may have a shape that projects directly from the interior circumferential surface of the band insertion hole. Moreover, there may be one or a plurality of engagement claws. In order to prevent the band engagement portion 44 from shifting from the band 50, three engagement claws 45 are preferred, as in the present embodiment, but this is not essential.

The band 50 extends from the band fixation portion 40, and is also formed in a strip shape capable of being inserted into the band insertion hole 42. A width of the band 50 is configured to be substantially equal to the width of the band insertion hole 42, and is preferably held at as constant a position as possible within the band insertion hole 42. A thickness dimension of the band 50 is configured to be smaller than a height dimension of the band insertion hole 42, and is configured to a size where the engagement claws 45 fit into the engagement grooves 52 in a state where a surface of the band 50 on the opposite side from a surface where the engagement grooves 52 are formed is in contact with the interior circumferential surface of the band insertion hole 42.

The engagement grooves 52 are formed at locations on the first main surface of the band 50, separated from the base end of the band 50 by a predetermined distance L1. A plurality of the engagement grooves 52 may be formed sequentially, without intervals therebetween, at one location on the band 50, or a single engagement groove may be provided at the single location on the band 50. In this example, three engagement grooves 52 are provided sequentially, matching the number of engagement claws 45. The number of engagement grooves 52 may be greater than the number of engagement claws 45, and may also be less. Locations on the first main surface of the band 50 other than those where the engagement grooves 52 are formed are formed to be flat, featuring no unevenness on which the engagement claws 45 might catch.

Each of the engagement grooves 52 are formed in a V-shaped groove extending along a width direction of the band 50. Of the two surfaces of the engagement groove 52, the surface closer to the base end side of the band 50 is inclined so as to grow gradually deeper toward the forefront end of the band 50. The surface closer to the forefront end side of the band 50 extends along the thickness direction of the band 50. Therefore, the engagement claws 45 can pass over the engagement grooves 52 comparatively easily in a direction from the forefront end of the band 50 toward the base end. In contrast, when the engagement claw 45 is oriented from the base end side of the band 50 toward the forefront end side, each of the engagement claws 45 abut the forefront end-side surface of the engagement grooves 52, and therefore have difficulty passing over the engagement grooves 52. Also, due to the engagement grooves 52 having such a shape, when the band 50 is inserted from the opening at the first end side toward the opening at the second end side of the band insertion hole 42, each of the engagement claws 45 can easily pass over the engagement grooves 52 formed in the band 50. In contrast, when the band 50 is pulled back from the opening at the second end side toward the opening at the first end side of the band insertion hole 42, each of the engagement claws 45 catch on the engagement grooves 52 formed in the band 50 and are unlikely to pass over the engagement grooves 52.

In addition, the distance L1 is preferably defined to a size enabling the band 50 to form a ring shape having a circumferential length L greater than an outer circumferential length of the wire harness 12 in a state where the engagement claws 45 are engaged with the engagement grooves 52.

In other words, the circumferential length L of the ring shape formed by the band 50 in a state where the engagement claws 45 are engaged with the engagement grooves 52 has a size determined by adding an axis-direction length of the band insertion hole 42 of the band fixation portion 40 to the distance L1, then subtracting a length of a portion of the band 50, where the engagement grooves 52 are formed, that is inside the band insertion hole 42. The distance L1 is preferably defined such that this circumferential length L is larger than the outer circumferential length of the wire harness 12.

Moreover, a state where the engagement claws 45 are engaged with the engagement grooves 52 such that the band 50 forms a ring shape having the smallest circumferential length may be posited as an example of the state where the engagement claws 45 are engaged with the engagement grooves 52. In other words, in a configuration providing a plurality of at least one of the engagement claw and the engagement groove, when at least one engagement claw engages with at least one engagement groove, the band can be fixated to the band fixation portion. Given this, a state where at least one engagement claw is engaged with at least one engagement groove such that the band forms a ring shape having the smallest circumferential length (for example, a case where, in a state where a band is inserted in a band insertion hole, only an engagement claw on an insertion direction forefront end side of the band is engaged with only an engagement groove on a base end side of the band) may be posited as an example of the state where the engagement claws are engaged with the engagement grooves. This is because when the circumferential length of the band in such a case is greater than the outer circumferential length of the wire harness, even when various states where the engagement claws engage with the engagement grooves are posited, the circumferential length of the band can be made larger than the circumferential length of the wire harness.

Also, as described below, a bundling member 70 such as adhesive tape may be wound around both sides of a location on the wire harness 12 where the wire fixating member with band 20 is mounted, and a displacement range of the wire fixating member with band 20 may be regulated in the extension direction of the wire harness 12. In such a case, the circumferential length L of the ring shape formed by the band 50 may be defined to be smaller than the outer circumferential length of the bundling member 70.

In view of each of the above circumstances, the circumferential length L of the ring shape formed by the band 50 is preferably a value in which between 5 and 20 mm is added to the outer circumferential length of the wire harness 12.

Ordinarily, in the work of fixating the band 50 to the band fixation portion 40, a band cutting tool may be used to pull the forefront end of the band 50 and cut an excess portion on the forefront end of the band 50. In view of this working length, in a state where the engagement claws 45 are engaged with the engagement grooves 52, the band 50 preferably extends slightly (specifically, 3 cm or more) from the band fixation portion 40. The length L1 is preferably defined in consideration of enabling the above-noted excess length portion to exist in addition to the total length of the band 50.

In addition, in this example, the engagement groove 52 is provided at a location separated from the forefront end of the band 50 by a distance La, as well.

In order to describe advantages of this, a case is posited in which engagement grooves are provided successively on a forefront end side of a band, as well. In such a case, even when the wire fixating member with band is mistakenly used on a wire harness having an outer circumferential length equal to or greater than that of the wire harness expected for use with the wire fixating member with band, the band can be fixated to the band fixation portion so as to be snugly tightened against the wire harness.

In addition, in a state where the band forms a ring shape having a circumferential length greater than the expected circumferential length, the band can be fixated to the band fixation portion. In such a case, the band may escape from a bundling member regulating positions of the two sides of the band.

Given this, in a configuration where the engagement groove 52 is provided at the location separated from the forefront end of the band 50 by the distance La, as well, the engagement groove 52 is formed at a somewhat limited location in the extension direction of the band 50, and no unevenness on which the engagement claws 45 might catch is formed any closer to the forefront end. Therefore, the circumferential length L of the ring shape formed by the band 50 can be inhibited from becoming too large and exceeding an expected range.

Accordingly, in a case where the wire fixating member with band 20 is mistakenly used on a wire harness having an outer circumferential length equal to or greater than that of the wire harness 12 expected for use with the wire fixating member with band 20, the band 50 cannot in fact be fixated to the band fixation portion 40. Therefore, mounting the wire fixating member with band 20 to the wrong wire harness can be effectively inhibited.

Even in a case where the use of wire harness 12 is not mistaken, a state in which the band 50 is fixated to the band fixation portion 40 in a state where the band 50 forms a ring shape having a circumferential length larger than the expected circumferential length L can be inhibited. Accordingly, the band 50 can be inhibited from escaping from the bundling member 70 regulating the positions of the two sides of the band 50.

Specifically, the engagement groove 52 is preferably formed at a limited location on the band 50 by forming one or between two and five engagement grooves 52 successively.

Moreover, the engagement groove 52 may be formed at the forefront end side of the band 50.

In addition, in order to achieve a single circumferential length forming a ring shape in a state where the band 50 is fixated to the band fixation portion 40, the engagement groove 52 is preferably formed at only one limited location on the band 50.

The bundling member 70 such as adhesive tape is wrapped around both sides of a location on the wire harness 12 where the wire fixating member with band 20 is mounted. In a case where adhesive tape is used as the bundling member 70, the adhesive tape is wound around a plurality of times until reaching a thickness where the band 50 does not escape. A bundling band or the like may also be employed as the bundling member.

An example of a manufacturing method of the wire harness with fixating member configured in this way is described.

First, as shown in FIG. 6, a plurality of wires are bundled together, the band 50 is wound around the outer circumference of the wire bundle, and the forefront end of the band 50 is inserted through the band insertion hole 42 of the band fixation portion 40. Then, the forefront end of the band 50, which extends from the band insertion hole 42, is pulled.

At this point, the band 50 may be pulled until the pulling of the band 50 stops in a state where a plurality (in this example, three) of the engagement claws 45 are engaged with a plurality (in this example, three) of the engagement grooves 52 or, as shown in FIG. 7, until the portion of the band 50 where the engagement grooves 52 are provided exits the band insertion hole 42.

In the former case, when the forefront end of the band 50 is cut by a blade 80 of a band cutting tool or the like, when necessary, the work of mounting the wire fixating member with band 20 concludes.

In the latter case, the band 50 is pulled back until at least one of the engagement claws 45 catches on the engagement grooves 52. In this way, in a state where the band 50 forms a ring shape having the circumferential length L greater than the outer circumferential length of the wire harness 12, the band 50 is retained by the band fixation portion 40 and fixated in this state. After this, the forefront end of the band 50 is cut by the blade 80 of the band cutting tool or the like, when necessary.

In a case where force is applied so as to pull the band 50 back through the band insertion hole 42 in a state where one engagement claw 45 is caught on the engagement groove 52, an engagement position of the engagement claw 45 and the engagement groove 52 may shift and other engagement claws 45 may engage with the engagement grooves 52. As a result, the plurality of engagement claws 45 may engage with the plurality of engagement grooves 52. Therefore, the band fixation portion 40 can achieve a degree of strength required to fixate the band 50.

Following the above, when necessary, the bundling member 70 such as adhesive tape is fixated to both sides of the wire fixating member with band 20 on the wire harness 12, and the wire harness with fixating member 10 is completed.

According to the wire fixating member with band 20 and the wire harness with fixating member 10 configured as described above, the engagement groove 52 is provided to the band 50 at a location separated from the base end of the band 50. Therefore, in a state where the engagement claw 45 is engaged with the engagement groove 52, the circumferential length of the ring shape formed by the band 50 can be defined to be at least a constant length. For example, in a state where the engagement claw 45 is engaged with the engagement groove 52, the engagement groove 52 is provided at a location separated by the distance L1 from the base end of the band 50, to a degree enabling the band 50 to form a ring shape having a circumferential length greater than the outer circumferential length of the wire harness 12. Accordingly, when the band 50 is wrapped around the wire harness 12 and fixated to the band fixation portion 40, the band 50 forms a ring shape having the circumferential length L, which is greater than the outer circumferential length of the wire harness 12. Thus, the wire fixating member with band 20 is mounted to the wire harness 12 in a state where the wire fixating member with band 20 can move around the outer circumference of the wire harness 12 and can also move in the extension direction of the wire harness 12. Accordingly, with a simple configuration and simple work, and without using a separate corrugated tube or iron core, for example, the wire fixating member with band 20 can be mounted to the wire harness 12 in a state capable of movement relative to the wire harness 12.

In addition, the engagement groove 52 is provided at a location separated from the forefront end of the band 50. Therefore, in a state where the engagement claw 45 is engaged with the engagement groove 52, a range of the circumferential length of the ring shape formed by the band 50 can be further restricted. Accordingly, the wire fixating member with band 20 can be inhibited from being mistakenly mounted to a wire harness having a different outer circumferential length than that of the wire harness 12 expected for use with the wire fixating member with band 20. In addition, in a state where the wire fixating member with band 20 is mounted to the wire harness 12, the band 50 can be inhibited from forming a ring shape in a state where the band 50 has a greater circumferential length than the outer circumferential length of the bundling member 70, and the wire fixating member with band 20 can be inhibited from escaping through the outer circumference of the bundling member 70.

Furthermore, by being provided at between one and six in number, the engagement groove 52 formed at a limited location on the band 50 can somewhat constrain the range over which the engagement claw 45 engages with the engagement groove 52 in the extension direction of the band 50, and the range of the circumferential length of the ring shape formed by the band 50 can be further limited.

In addition, the engagement groove 52 is provided at only one location on the band 50. Therefore, the location at which the engagement claw 45 engages with the engagement groove 52 can be limited to one location, and the circumferential length of the ring shape formed by the band 50 can be limited to one circumferential length. Accordingly, the wire fixating member with band 20, which is manufactured for the wire harness 12 having a certain outer circumferential length, can be inhibited from being mistakenly used on a wire harness having a different outer circumferential length.

Modifications

As described above in the embodiment, the engagement groove 52 is formed at the location on the band 50 separated by the predetermined distance L1 from the base end portion of the band 50. The distance L1 is determined in accordance with the outer circumferential length of the wire harness 12.

Given this, the wire fixating member with band 20 may be manufactured according to the outer circumferential length of the wire harness 12 to which the fixating member 20 is to be applied.

For example, in the example shown in FIGS. 8 and 9, a case is posited in which a wire fixating member with band 20B is applied to a wire harness 12B, which is smaller than the outer circumferential length of the wire harness 12 posited in the embodiment above.

In such a case, a fixating member in which the engagement groove 52 is formed at a location on the band 50 separated by a predetermined distance L2 from the base end portion of the band 50 is prepared as the wire fixating member with band 20B. The distance L2 is determined in accordance with the outer circumferential length of the wire harness 12B, and is smaller than the distance L1.

Furthermore, for example, in the example shown in FIGS. 10 and 11, a case is posited in which a wire fixating member with band 20C is applied to a wire harness 12C, which is even smaller than the outer circumferential length of the wire harness 12B posited in the example above.

In such a case, a fixating member in which the engagement groove 52 is formed at a location on the band 50 separated by a predetermined distance L3 from the base end portion of the band 50 is prepared as the wire fixating member with band 20C. The distance L3 is determined in accordance with the outer circumferential length of the wire harness 12C, and is smaller than the distances L1 and L2.

Then, for example, when fixating members are prepared having a diameter of 30 mm, a diameter of 20 mm, and a diameter of 10 mm in a state where the band 50 forms a ring shape, it is possible to accommodate the wire harnesses 12, 12B, and 12C, which have various diameters. For example, the band 50 forming a ring shape having the diameter of 30 mm can be applied to a wire harness having a diameter of at least 3 mm and less than 10 mm. The band 50 forming a ring shape having the diameter of 20 mm can be applied to a wire harness having a diameter of at least 10 mm and less than 20 mm. The band 50 forming a ring shape having the diameter of 30 mm can be applied to a wire harness having a diameter of at least 20 mm and less than 30 mm.

In addition, in the above-described embodiment, an example was described in which one or a successive plurality of engagement grooves 52 are provided in only one location in the extension direction of the band 50. However, as shown in FIG. 12, one or a successive plurality of engagement grooves 52 may also be provided at each of a plurality of locations provided at intervals in the extension direction of the band 50.

In the example of a wire fixating member with band 120 shown in FIG. 12, one or a successive plurality of engagement grooves 52 (in the drawing, three successive engagement grooves 52) are formed on a band 150 (corresponding to the band 50) at three locations separated by distances L1, L2, and L3 from the base end of the band 150. According to this example, in a state where the band 150 is fixated to the band fixation portion 40, the band 150 can form a ring shape having a three-stage outer circumferential length, and does not form a ring shape having an intermediate outer circumferential length. Therefore, in a state where a gap is provided to the outer circumference of a wire harness, the band 150 can be readily wrapped around and mounted to wire harnesses having various outer circumferential lengths, providing excellent versatility.

In addition, in the above-described embodiment, the description centered on an example in which three engagement claws 45 are provided and three engagement grooves 52 are provided. However, any number of these components may be provided.

For example, as in the example shown in FIG. 13, one engagement claw 245 and one engagement groove 252 may be provided.

In addition, as in the example shown in FIG. 14, three engagement claws 345 and a larger number of engagement grooves 352 (in this example, six) may be provided.

As shown in these examples, any number of engagement claws and engagement grooves may be provided, and the number of each component need not be the same. However, when the number of engagement grooves is between one and six, approximately, a position where the engagement claw engages with the band is somewhat limited, and therefore the circumferential length of the ring shape formed by the band can be somewhat constrained.

The configurations described in the above embodiment and modifications can be combined as appropriate so long as they do not contradict each other.

In the above, the present invention is described in detail. However, the above description is, in all aspects, for exemplary purposes and the present invention is not limited by the description. Numerous modifications not given as examples are understood to be conceivable without departing from the scope of the present invention.

### DESCRIPTION OF REFERENCE NUMERALS

10 Wire harness with fixating member

12, 12B, 12C Wire harness

20, 20B, 20C, 120 Wire fixating member with band

30 Vehicle fixation portion

40 Band fixation portion

42 Band insertion hole

44 Band engagement portion

45, 245 Engagement claw

50, 150 Band

52, 252, 352 Engagement groove

70 Bundling member

L1, L2, L3 Distance

1. A wire harness with fixating member comprising:
a wire harness; and
a wire fixating member with band comprising:
a vehicle fixation portion capable of fixating to a vehicle;
a band fixation portion provided to the vehicle fixation portion and having an engagement claw inside a band insertion hole; and
a band formed in a strip shape extending from the band fixation portion, and having, at a location separated from a base end of the band by a predetermined distance, an engagement groove with which the engagement claw can engage and not having any engagement groove formed at a portion within the predetermined distance from the base end of the band,
wherein, in a state where a gap can be provided with respect to an outer circumference of the wire harness, the engagement claw engages with the engagement groove and a portion of the band within the predetermined distance from the base end of the band is wrapped around the wire harness, in which state the wire fixating member with band is attached to the wire harness.

2. The wire harness with fixating member according to claim 1, wherein the engagement groove is provided at the location separated from the base end of the band by the predetermined distance to a degree enabling the band to form a ring shape of a circumferential length greater than an outer circumferential length of the wire harness in a state where the engagement claw is engaged with the engagement groove.

3. The wire harness with fixating member according to claim 1 or claim 2, wherein the engagement groove is provided at a location separated from a forefront end of the band.

4. The wire harness with fixating member according to any one of claims 1 to 3, wherein between one and six engagement grooves are provided.

5. The wire harness with fixating member according to any one of claims 1 to 4, wherein the engagement groove is provided at only one location on the band.

6. The wire harness with fixating member according to claim 1, wherein the band has, at a location at an interval toward a forefront end of the band from the engagement groove, another engagement groove.

7. (canceled)
